(19) United States
(12) Patent Application Publication
(10) Pub. No.: US 2017/0064764 A1
(43) Pub. Date: Mar. 2, 2017

(54) CONCURRENT DECODING OF ONE OR MORE SYSTEM INFORMATION BLOCKS (SIBS)

(71) Applicant: QUALCOMM Incorporated, San Diego, CA (US)

(72) Inventors: Lei KE, San Diego, CA (US); Raghu Narayan CHALLA, San Diego, CA (US); Udayan Murli BHAWNANI, San Diego, CA (US); Ning YIN, San Diego, CA (US); Daniel AMERGA, San Diego, CA (US)

(21) Appl. No.: 15/221,108

(22) Filed: Jul. 27, 2016

Related U.S. Application Data
(60) Provisional application No. 62/210,682, filed on Aug. 27, 2015.

(51) Int. Cl. H04W 76/02; H04J 11/00; H04W 72/10; H04W 76/04

(52) U.S. Cl. CPC H04W 76/027; H04W 76/045; H04J 11/0073; H04W 72/10; H04W 72/1231

(57) ABSTRACT

Certain aspects relate to methods and apparatus for obtaining system information by an apparatus comprising concurrently maintaining a first buffer for combining multiple transmissions of at least a first type of system information block (SIB) message across different system information (SI) message windows and a second buffer for combining multiple transmissions of at least a second type of SIB message within an SI window, and decoding at least first and second types of SIB messages based on contents in the first and second buffers.

### CLAIM OF PRIORITY UNDER 35 U.S.C. §119

The present Application for Patent claims benefit of U.S. Provisional Patent Application Ser. No. 62/210,682, filed Aug. 27, 2015 and assigned to the assignee hereof and hereby expressly incorporated by reference herein.

### BACKGROUND

Field of the Disclosure

Certain aspects of the present disclosure generally relate to wireless communications systems and, more specifically, to concurrent decoding of one or more system information blocks (SIBs).

Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station. A base station may transmit data and control information on the downlink to a UE and/or may receive data and control information on the uplink from the UE.

System information blocks (SIBs) include various important types of information for connecting to and maintaining connections with wireless Long Term Evolution (LTE) networks. Failure to decode one or more SIBs may result in radio link failure errors or service loss. Increasing the robustness of SIB decoding is thus desirable.

### SUMMARY

Certain aspects of the present disclosure provide a method for obtaining system information by an apparatus. The method generally includes concurrently maintaining a first buffer for combining multiple transmissions of at least a first type of SIB message across different system information (SI) message windows and a second buffer for combining multiple transmissions of at least a second type of SIB message within an SI window, and decoding at least first and second types of SIB messages based on contents in the first and second buffers.

Various other aspects provide apparatus, systems and computer program products for performing the operations described above. Various aspects and features of the disclosure are described in further detail below.

### BRIEF DESCRIPTION OF THE DRAWINGS

FIG. 1 illustrates an example of a wireless communications network, in which aspects of the present disclosure may be practiced.

FIG. 2 illustrates an example of a frame structure in a wireless communications network.

FIG. 2A illustrates an example format for the uplink in LTE.

FIG. 3 illustrates an example of an enhanced Node B in communication with a user equipment device (UE) in a wireless communications network, in accordance with certain aspects of the present disclosure.

FIG. 4 conceptually illustrates an example of SIB scheduling, in accordance with certain aspects of the present disclosure.

FIG. 5 illustrates an example of a SIB modification period, in accordance with certain aspects of the present disclosure.

FIG. 6 illustrates an example operations for obtaining system information, in accordance with certain aspects of the present disclosure.

FIG. 7 illustrates an example concurrent decoding of one or more SIBs during initial SIB1 acquisition, in accordance with certain aspects of the present disclosure.

FIG. 8 illustrates an example concurrent decoding of one or more SIBs over time including at least one SIB modification period, in accordance with certain aspects of the present disclosure.

### DETAILED DESCRIPTION

Certain aspects of the present disclosure provide techniques that may allow for concurrent decoding of one or more SIBs (e.g., one or more SIB messages). Network nodes, such as eNBs, broadcast system information messages including one or more SIBs including information used to access and maintain access to a cell. Decoding SIBs enables many scenarios, for example, such as initial attach, handover to a new cell, cell reselection and/or monitoring for critical information.

A SIB decoding failure may result in either an out of sync (OOS) or radio link failure (RLF) error. A wireless node may experience difficulties decoding a SIB for various reasons such as a physical impairment to the wireless node, the wireless node is in deep fading, the wireless node is experiencing interference, and/or the wireless node is at the cell edge with poor coverage. Aspects of the present disclosure provide an improved approach to decoding one or more SIB blocks.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

### Example Wireless Network

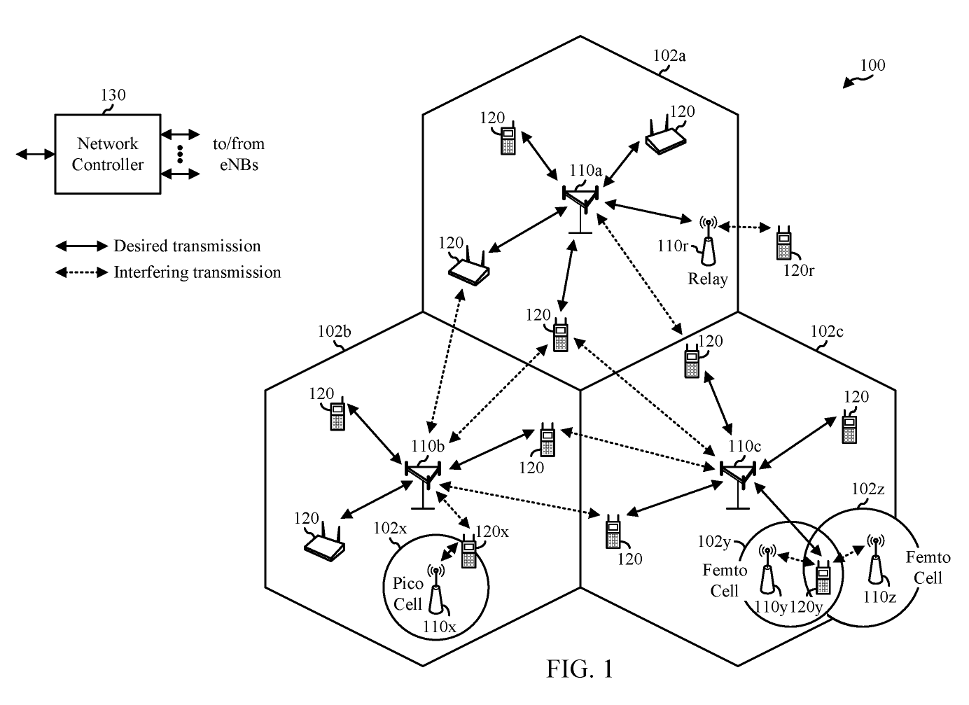

FIG. 1 shows a wireless communication network 100 (e.g., an LTE network), in which the techniques described herein may be practiced. For example, the techniques may be utilized to reduce latency when UEs 120 perform various access procedures with eNBs 110.

The wireless network 100 may include a number of evolved Node Bs (eNBs) 110 and other network entities. An eNB may be a station that communicates with user equipment devices (UEs) and may also be referred to as a base station, a Node B, an access point, etc. Each eNB 110 may provide communication coverage for a particular geographic area. The term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB. In the example shown in FIG. 1, eNBs 110a, 110b, and 110c may be macro eNBs for macro cells 102a, 102b, and 102c, respectively. eNB 110x may be a pico eNB for a pico cell 102x. eNBs 110y and 110z may be femto eNBs for femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may be a UE that relays transmissions for other UEs. In the example shown in FIG. 1, a relay station 110r may communicate with eNB 110a and a UE 120r in order to facilitate communication between eNB 110a and UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 watts) whereas pico eNBs, femto eNBs, and relays may have a lower transmit power level (e.g., 1 watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE 120 may be stationary or mobile. A UE 120 may also be referred to as a terminal, a mobile station, a subscriber unit, a station, etc. A UE 120 may be a cellular phone, a personal digital assistant (PDA), a wireless modem, a wireless communication device, a handheld device, a laptop computer, a cordless phone, a wireless local loop (WLL) station, a tablet, etc. A UE 120 may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz, and there may be 1, 2, 4, 8, or 16 subbands for system bandwidth of 1.25, 2.5, 5, 10, or 20 MHz, respectively.

A UE may be within the coverage of multiple eNBs. One of these eNBs may be selected to serve the UE. The serving eNB may be selected, for example, based on various criteria such as received power, received quality, path loss, signal-to-noise ratio (SNR), etc.

A UE may operate in a dominant interference scenario in which the UE may observe high interference from one or more interfering eNBs. A dominant interference scenario may occur due to restricted association. For example, in FIG. 1, UE 120y may be close to femto eNB 110y and may have high received power for eNB 110y. However, UE 120y may not be able to access femto eNB 110y due to restricted association and may then connect to macro eNB 110c with lower received power (as shown in FIG. 1) or to femto eNB 110z also with lower received power (not shown in FIG. 1). UE 120y may then observe high interference from femto eNB 110y on the downlink and may also cause high interference to eNB 110y on the uplink.

A dominant interference scenario may also occur due to range extension, which is a scenario in which a UE connects to an eNB with lower path loss and lower SNR among all eNBs detected by the UE. For example, in FIG. 1, UE 120x may detect macro eNB 110b and pico eNB 110x and may have lower received power for eNB 110x than eNB 110b. Nevertheless, it may be desirable for UE 120x to connect to pico eNB 110x if the path loss for eNB 110x is lower than the path loss for macro eNB 110b. This may result in less interference to the wireless network for a given data rate for UE 120x. However, in certain cases, being served by the pico eNB 110x while in a cell range expansion (CRE) region of the pico eNB 110x may not provide much benefit and in fact may lead to service interruption. In accordance with certain aspects of the present disclosure, the UE 120x may avoid being served by the pico eNB 110x, in response to detecting certain conditions including high Doppler, high relative timing/frequency offset, processing limitations, and low battery power. These aspects are discussed in detail below.

In an aspect, communication in a dominant interference scenario may be supported by having different eNBs operate on different frequency bands. A frequency band is a range of frequencies that may be used for communication and may be given by (i) a center frequency and a bandwidth or (ii) a lower frequency and an upper frequency. A frequency band may also be referred to as a band, a frequency channel, etc. The frequency bands for different eNBs may be selected such that a UE can communicate with a weaker eNB in a dominant interference scenario while allowing a strong eNB to communicate with its UEs. An eNB may be classified as a “weak” eNB or a “strong” eNB based on the relative received power of signals from the eNB received at a UE (e.g., and not based on the transmit power level of the eNB).

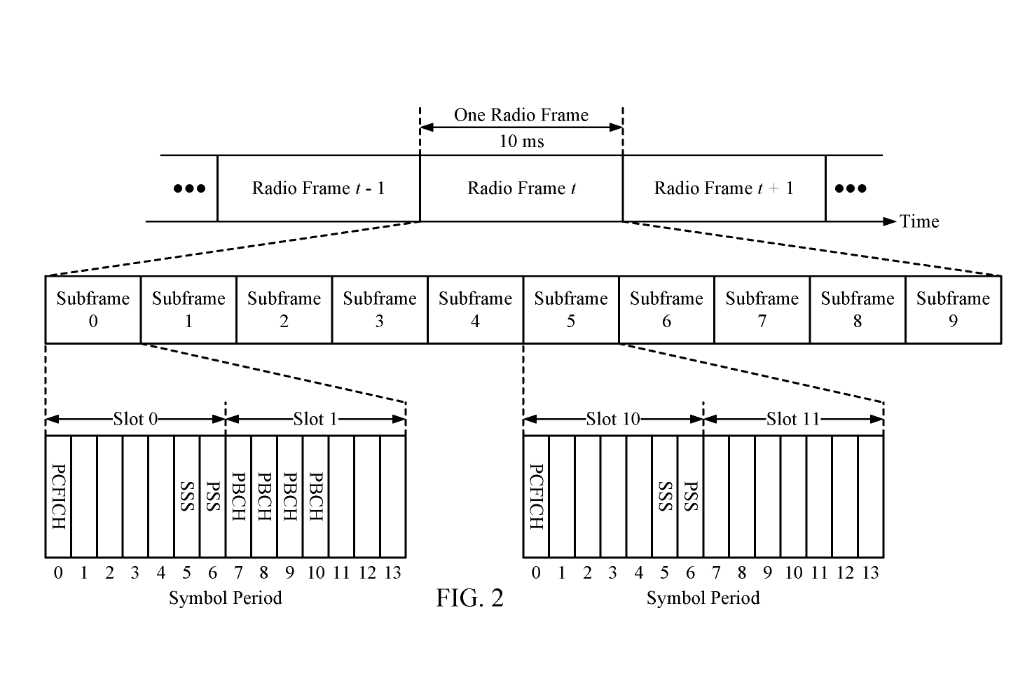

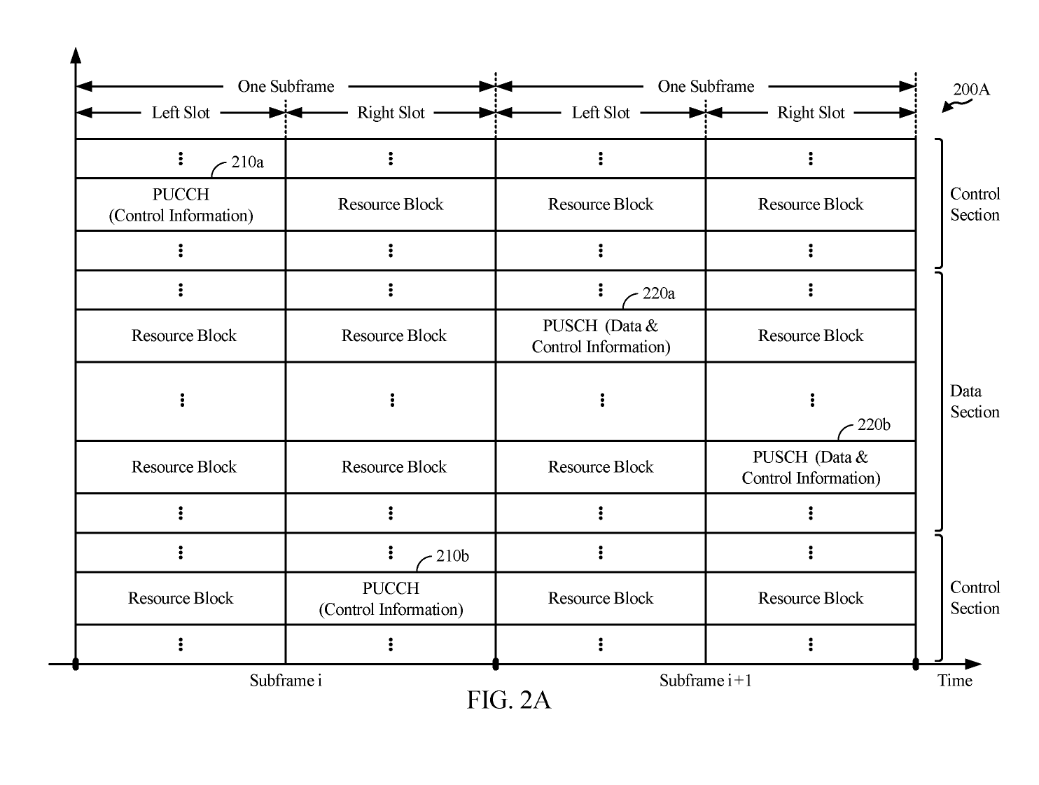

FIG. 2 shows a frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., L=7 symbol periods for a normal cyclic prefix (as shown in FIG. 2) or L=6 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP), as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as shown in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe (not shown in FIG. 2). The PHICH may carry information to support hybrid automatic repeat request (HARD). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

FIG. 2A shows an exemplary format 200A for the uplink in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 2A results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the Node B. The UE may transmit control information in a Physical Uplink Control Channel (PUCCH) 210a, 210b on the assigned resource blocks in the control section. The UE may transmit data or both data and control information in a Physical Uplink Shared Channel (PUSCH) 220a, 220b on the assigned resource blocks in the data section. An uplink transmission may span both slots of a subframe and may hop across frequency as shown in FIG. 2A.

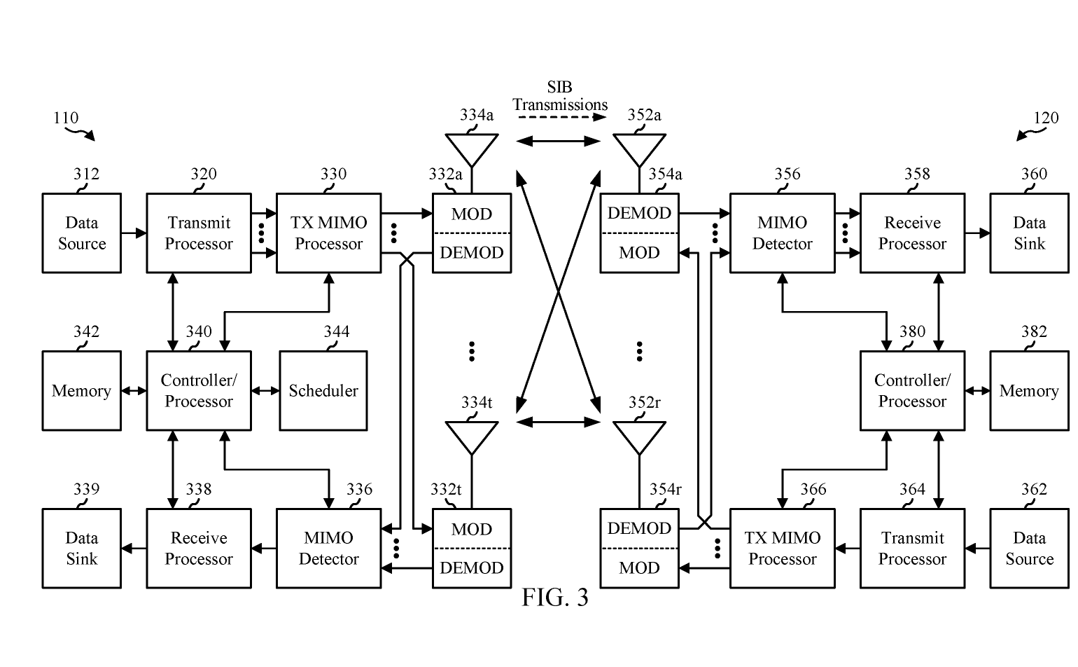

FIG. 3 shows a block diagram of a design of a base station or an eNB 110 and a UE 120, which may be one of the base stations/eNBs and one of the UEs in FIG. 1. eNB 110 and UE 120 may be configured to perform operations described herein. For example, as illustrated, eNB 110 may be configured to convey system information to UE 120.

For a restricted association scenario, the eNB 110 may be macro eNB 110c in FIG. 1, and UE 120 may be UE 120y. The eNB 110 may be a base station of some other type. The eNB 110 may be equipped with T antennas 334a through 334t, and the UE 120 may be equipped with R antennas 352a through 352r, where in general T≧1 and R≧1.

At the eNB 110, a transmit processor 320 may receive data from a data source 312 and control information from a controller/processor 340. The control information may be for the PBCH, PCFICH, PHICH, PDCCH, etc. The data may be for the PDSCH, etc. The transmit processor 320 may process (e.g., encode and symbol map) the data and control information to obtain data symbols and control symbols, respectively. The transmit processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide T output symbol streams to T modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively.

At the UE 120, antennas 352a through 352r may receive the downlink signals from the eNB 110 and may provide received signals to demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all R demodulators 354a through 354r, perform MIMO detection on the received symbols, if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may generate reference symbols for a reference signal. The symbols from the transmit processor 364 may be precoded by a TX MIMO processor 366 if applicable, further processed by modulators 354a through 354r (e.g., for SC-FDM, etc.), and transmitted to the eNB 110. At the eNB 110, the uplink signals from the UE 120 may be received by antennas 334, processed by demodulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

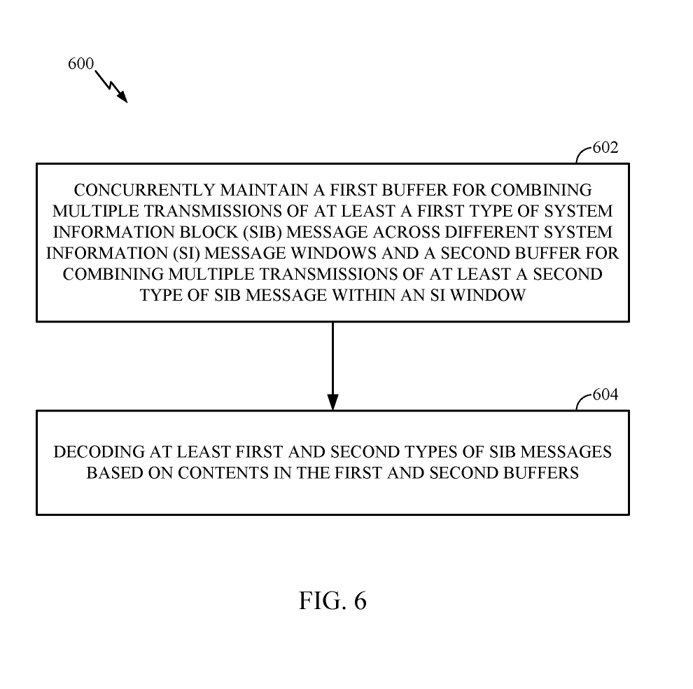

The controllers/processors 340, 380 may direct the operation at the eNB 110 and the UE 120, respectively. The controller/processor 380 and/or other processors components, and/or modules at the UE 120 may perform or direct operations 600 shown in FIG. 6 and/or other processes for the techniques to enhance system access for E-UTRAN, as described herein. The controller/processor 340 and/or other processors, components and/or modules at eNB 110 may perform or direct other processes for techniques to enhance system access for E-UTRAN, as described herein. The memories 342 and 382 may store data and program codes for eNB 110 and UE 120, respectively. A scheduler 344 may schedule UEs for data transmission on the downlink and/or uplink.

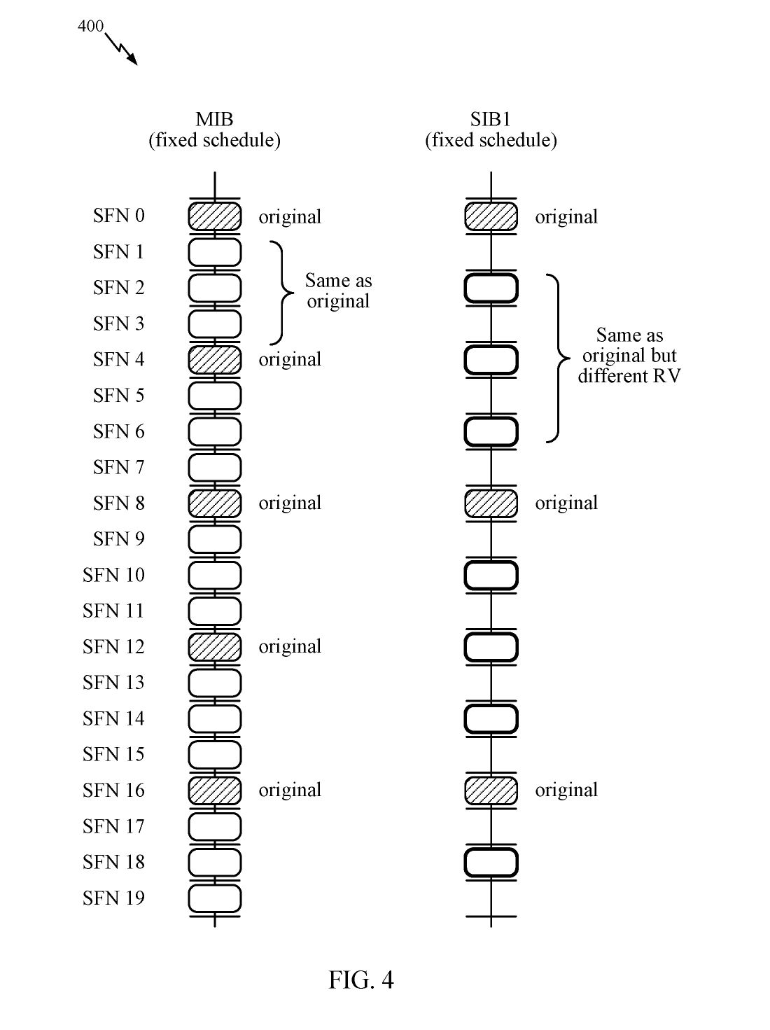

According to certain aspects, a master information block (MIB) is broadcast by a wireless node, such as an eNB, for example. The MIB may include basic information for initially attaching to a cell. During cell acquisition, the UE detects and reads the MIB to acquire information necessary for camping on a cell. As illustrated in FIG. 4, a new MIB is broadcast every four radio frames, for example at subframes 0, 4, 8, 12, and 16. Copies of the MIB are broadcast every radio frame, for example where the MIB broadcast at subframes 1-3 are copies of the MIB broadcast at subframe 0.

There are many defined types of SIB messages (e.g., SIBs), SIB1, SIB2, SIB3 . . . each carrying various types of system information (SI). Generally, SIB messages include broadcast information (e.g., critical broadcast information) and decoded information carried in various SIB messages is required for initial attach, handover, cell reselection, and monitoring for critical information, such as earthquake and tsunami warning service (ETWS) or commercial mobile alert system (CMAS).

Each SIB may be broadcast on a schedule that is defined by a schedule carried in the system information block type 1 (SIB1). Similar to the MIB, the SIB1, as seen in FIG. 4, may be broadcast on a fixed schedule every 8 radio frames for a periodicity of 80 ms and repetitions are made within the 80 ms, for example. For example, the first transmission of SIB1 may be scheduled in subframe number (SFN) 5 of radio frames for which the SFNmod 8=0, and repetitions may be scheduled in SFN 5 of all other radio frames for which SFN mod 2=0. That is, a new SIB1 is sent every 8 frames or 80 ms and within the 80 ms period, the same SIB1 is repeated every 2 frames or 20 ms. The repetitions may each include a different redundancy version (RV), but are otherwise the same, for example. The UE may combine the repetitions to calculate a LLR for use in decoding the combined repetitions.

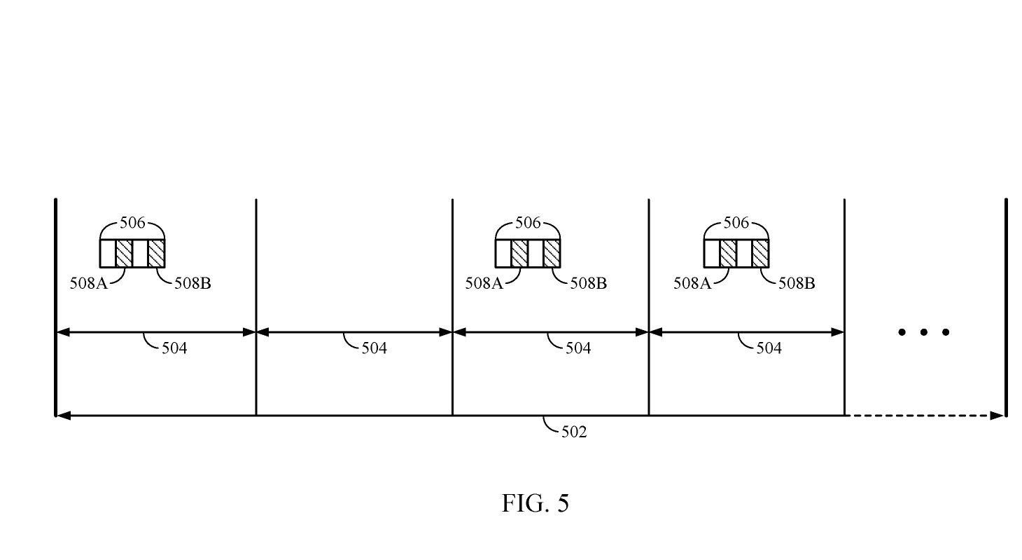

FIG. 5 illustrates an example of a SIB modification period 502, in accordance with certain aspects of the present disclosure. System information may be changed after a SIB modification period 502. An indication of a length of a SIB modification period 502 may be carried in SIB2. The SIB modification period 502 may generally be defined in terms of a number of radio frames 504 and may be a function of the DRX cycle. Within a particular SIB modification period 502, SI of the SIB remains unchanged and the SI may be repeated during the modification period. When SI is modified, the eNB may notify the UE about the upcoming change and transmit the updated SI in a new SIB in the next SIB modification period.

SIBs, aside from SIB1, may be transmitted within one or more SI window 506, separate from the SIB modification window. The SI window 506 indicates when a SIB is scheduled to be transmitted. The SI window does not specify the exact subframe number for the transmission. Rather, a particular SIB may be transmitted within an SI message 508A somewhere within a duration of the SI window starting at the SFN specified in the SIB1. A UE may attempt to acquire the SIB by listening starting from the beginning of the SI window for SI messages including the SIB until the SIB is acquired.

The SI window may be defined to enable retransmission of the SI message within the SI window. As shown, SI message 508B may be a retransmission of SI message 508A. In such cases, the SI window 506 is necessarily longer than the SI message 508A. This allows the SI message 508A to be transmitted more than once within the SI window 506. Transmitting the SI message 508A multiple times within the SI window 506 allows for a measure of redundancy as a UE that fails to receive an initial transmission or receives only a portion of the initial transmission may receive a retransmission.

Where a SI message 508A is retransmitted during a particular SI window 506, the received SI messages may be combined by a UE. A calculated LLR value may be used to decode the SI messages received within the particular SI window 506. This calculated LLR value is generally discarded at the beginning of a new SI window 506. However, where channel conditions are unfavorable, the UE may not be able to decode a particular SI message. Additionally, if a particular SI message is not retransmitted during a particular SI window, the receiving UE will not be able to combine the SI message within the SI window.

According to certain aspects, SI messages may be combined across different SI windows. Within a particular SIB modification window, SI within a particular SI message may remain relatively unchanged. For example, a network may use the same information bits for multiple SI message transmissions across different SI windows. Where new data is included in a SI message, a new-data indicator (NDI) bit may be set, indicating that a particular SI message includes new information bits as compared to a previous version of the SI message. Where multiple SI messages are received across different SI windows, but within the same SIB modification boundary and with the same information bits, a UE may combine the SI messages across the different SI windows. This allows a UE to achieve some level of time diversity and improve SIB decoding performance. However, with some SI messages, the information content may change across different SI message windows. For example, SIBs with ETWS and CMAS messages may have large data payloads which may need to be spread across multiple SI messages. Moreover, SIB behavior at the physical (PHY) layer is not well defined as current 3GPP definitions address SI content at the radio resource control (RRC) layer rather than at the PHY layer.

### Concurrent Decoding of One or More Sibs

As noted above, certain aspects of the present disclosure provide techniques that may help improve the decoding of SIB messages. In some cases, different types of SIB messages may be decoded concurrently. As used herein, the term concurrent decoding may refer to concurrently maintaining at least two buffers to store different types of SIB messages to be decoded. The at least two buffers may reuse buffers dedicated to decoding particular SIBs in existing hardware.

FIG. 6 illustrates a block diagram of example operations for obtaining system information, in accordance with certain aspects of the present disclosure. The operations 600 may be performed by an apparatus, such as a UE 120 as illustrated in FIG. 1. The operations 600 begin at 602 where the apparatus concurrently maintains a first buffer for combining multiple transmissions of at least a first type of system information block (SIB) message across different system information (SI) message windows and a second buffer for combining multiple transmissions of at least a second type of SIB message within an SI window. At 604, the apparatus decodes at least the first and second types of SIB messages based on contents in the first and second buffers.

As discussed above, a first and second buffer may be used to combine multiple transmissions of various types of SIB messages both within and across SI windows concurrently within a SIB modification period, allowing for improved SIB decoding performance. Combining SI messages across multiple SI message windows may be performed until RRC indicates that a particular SI message has been successfully decoded either by combining within a SI message window or across multiple SI message windows. Terminating the combination of multiple SI messages across multiple SI message windows may occur if one or more conditions are met. For example, combining across multiple SI message windows may be terminated on expiration of the SIB modification period, or if the apparatus cannot decode a SI message or SIB for a threshold period of time. In the latter case, the UE may then declare a SIB read failure.

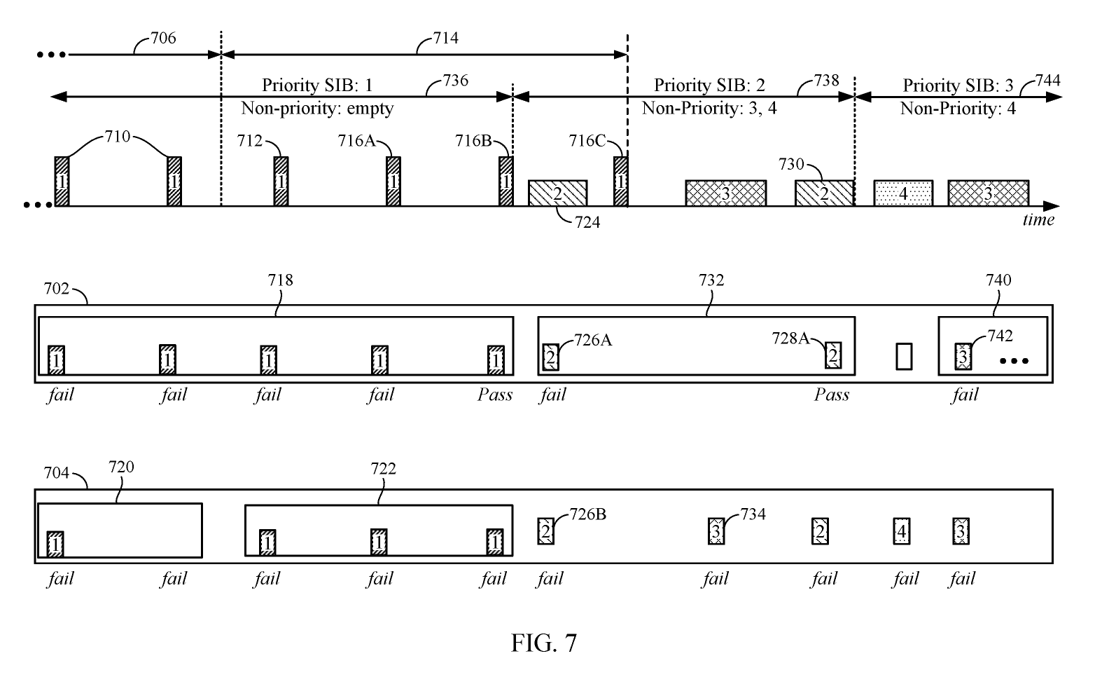

FIG. 7 illustrates an example concurrent SIB decoding during initial SIB1 acquisition, in accordance with certain aspects of the present disclosure. An apparatus may be configured with at least two buffers 702 and 704 used for decoding SI messages. Rather than dedicating a first buffer 702 of the at least two buffers for decoding SIB1 messages, the first buffer 702 may be used for combining across multiple SI windows. As discussed above, a new SIB1 may be sent every 80 ms and repeated at 20 ms intervals. As shown, a new or first SIB1 (not shown) may be sent over during an 80 ms first SIB1 window 706. One or more first repeated SIB1 710 of the first SIB may be received. A new, second SIB1 712 may be received during a second SIB1 window 714, along with one or more second repeated SIB1 716A-C. A received SIB1 transmission (e.g., one or more of the one or more repeated SIB1 710) may be combined 718 with other received SIB1 (e.g., second SIB1 712, repeated second SIB1 716A-C, etc.) transmissions across more than an 80 ms window, but within a SIB modification period in the first buffer 702. The second buffer 704 of the at least two buffers may be used for decoding all the other SIBs aside from SIB1.

According to aspects of the present disclosure, the second buffer 704 may also be used for decoding SIB1 along with the other SIBs. For example, the second buffer 704 may be used to decode SIB1 within the 80 ms first SIB1 window 706 by combining 720 received SIB1, such as first repeated SIB1 710. If the first SIB1 window 706 ends without a successful decoding of SIB1, the contents of the second buffer 704 may be cleared and the second buffer 704 used to decode SIB1 within the second SIB1 window 714 by combining 722 the second SIB1 712 and repeated second SIB1 716A-B. Combining SIB1 with a SIB1 window in the second buffer 704 provides level of redundancy as a new SIB1 is sent every 80 ms and contents of the new SIB1 may differ from a previous SIB1 and this difference may prevent combining across SIB1 windows.

After successfully decoding the SIB1 at 708 and obtaining the scheduling information for the other SIBs from SIB1, the first buffer 702 and second buffer 704 may be used for combining the other SIBs across their SI windows. For example, a first SIB2 726A, 726B may be placed in both the first 702 and second buffers 704 after being received during an SI window 724. The first received SIB2 726A may be placed in the first buffer 702 and combined with a second received SIB2 728A received during another SI window 730. Combining across multiple SI windows may occur when the second received SIB2 728A belongs to a same SIB modification boundary and the same information bits are present in both the first received SIB2 726A and second received SIB2 728A (for example, as indicated by the NDI). If the combined first received SIB2 726A and second received SIB2 728A is successfully decoded by combining 732, the decoded SIB2 is passed up to the RRC layer and cleared from the first buffer 702.

As the second buffer 704 supports combining (e.g., only) within a single SI window, the first received SIB2 726B in the second buffer 704 may be combined with any retransmissions of the SIB2 only within the SI window 724 of the first received SIB2. This provides for a level of robustness in case the information included in a particular SIB changes across SI windows. If the SI window 724 of the first received SIB2 726B expires, another SIB, such as a first received SIB3 734, may replace the first received SIB2 726B in the second buffer 704 for combining and decoding, even if the first received SIB2 726B was not yet successfully decoded.

According to certain aspects of the present disclosure, as hardware limitations may only allow one SIB at a time to be combined across multiple SI windows in the first buffer 702, SIBs may be chosen for combining in the first buffer 702 based on a priority scheme. This priority scheme dictates which SIB to store for combining in the first buffer where SIBs of a lower priority are decoded after SIBs of a higher priority have been successfully decoded. Prioritization of the SIBs for decoding in the first buffer may be applied to facilitate efficient utilization of the first buffer. This prioritization may vary depending on the RRC state (e.g., an operating mode) of the apparatus, as whether various SIBs are considered mandatory may depend on the operating mode of the apparatus. For example, in connected mode, only SIBs 1, 2, and 10-12 are considered mandatory by RRC. Thus in connected mode, combining on the first buffer can be prioritized such that SIB1 is prioritized over SIB2, which is prioritized over SIBs 10, 11, and 12, which are prioritized over all other SIBs. Put another way, in connected mode, SIB1>SIB2>(SIB10, SIB11, SIB12)> all other SIBs. Blocks of SIBs, such as SIBs 10, 11, and 12 above, within parentheses may be assigned the same priority and sequenced based on their SIB index with the lowest first.

Where the apparatus is in an idle mode, all SIBs are considered mandatory by RRC. In the idle mode, combining on the first buffer can be prioritized such that SIB1 is prioritized over SIB2, which is over SIBs 3 and 4, which are over SIBs 10, 11, and 12, which are over all other SIBs. Put another way, in idle mode, SIB1>SIB2>(SIB3, SIB4)>(SIB10, SIB11, SIB 12)> all other SIBs.

For example, in FIG. 7, prioritization may be such that SIB1>SIB2>(SIB3, SIB4). After SIB1 is successfully decoded during a SIB1 decoding pass 736 and the schedule for SIB2 becomes known. SIB combining across multiple SI windows may then be scheduled for the first buffer 702. A repeated SIB1 716C received after the scheduling for SIB2 may be ignored where the SIB1 716C is a retransmission of a previously successfully decoded SIB1 within the SIB modification period. A first received SIB3 734 received after the scheduling for SIB2 in a SIB2 decoding pass 738 may not be placed in the first buffer 702 as SIB2 has priority over SIB3. The first received SIB3 734 may be placed in the second buffer 704 as the second buffer 704 only combines within a SI window and thus prioritization does not apply. As the second buffer 704 combines within a SI window, if the second buffer 704 previously includes information from a previous SIB that was not successfully combined (e.g., un-combined) within a previous SI window, the previous SIB may be overwritten or otherwise removed from the second buffer. After a SIB2 is successfully decoded in the SIB2 decoding pass 738, combining 740 across multiple SI windows of a second received SIB3 742 may occur in the first buffer in a SIB3 decoding pass 744. The SIB3 may be prioritized over SIB4 as the SIB3 has a lower SIB index, and so on.

In some implementations, prioritization rules may not apply, for example, where a modem has buffers sufficient to support concurrent SIB decoding of multiple SIBs together. However, such implementations are expected to be unlikely as multiple SIBs may be composed together in a single SI message, making it difficult to design an appropriate buffer size larger than one sufficient for decoding a single SIB.

As discussed above, not all SIBs are considered mandatory. In some RRC states, certain SIBs are not very important and a SIB read failure has very little impact on the apparatus. For example, where evolved multimedia broadcast multicast services (eMBMS) are not supported by an apparatus, a failure to read SIBs 13, 15, and 16 has no impact on the apparatus. In some embodiments, an apparatus may maintain a list of mandatory SIBs and only declare a RLF or OOS if the apparatus fails to decode a mandatory SIB. This list of mandatory SIBs may vary depending on the RRC state of the apparatus. For example, only SIBs 1, 2, and 10-12 are considered mandatory in connected mode, while all SIBs are considered mandatory in idle mode. Thus a failure to decode SIB 4 may not trigger a RLF or OOS error in connected mode, but may trigger an error in idle mode.

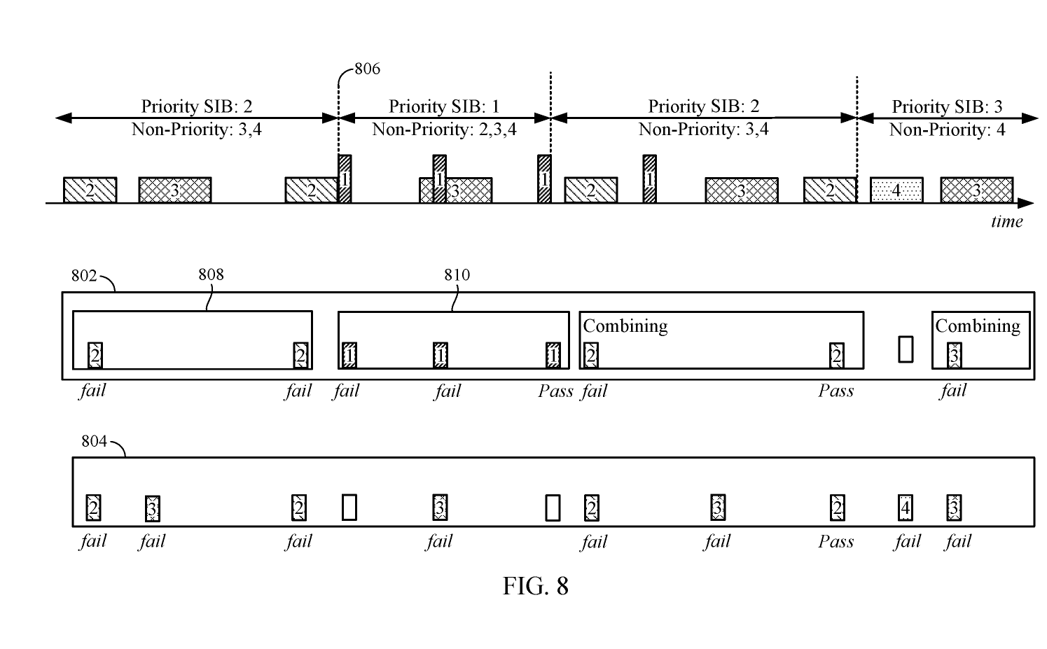

FIG. 8 illustrates an example concurrent decoding over time including at least one a SIB modification period, in accordance with certain aspects of the present disclosure.

System information may be changed after a SIB modification period or beyond a SIB modification boundary 806. Updates to system information may be communicated in, for example, SIB1. As one SIB may be combined in the first buffer 802 at a time, if a SIB1 needs to be decoded while another SIB, such as SIB2, is being combined in the first buffer 802, combining 808 the another SIB may be terminated (regardless of whether such SIB is decoded successfully or not) and the first buffer 802 may then be used for combining 810 the SIB1. A second buffer 804 may be used for combining the other SIBs across their SI windows.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may be performed by any suitable corresponding counterpart means-plus-function components.

For example, means for concurrently maintaining and/or means for decoding may include one or more processors, such as the receive processor 358 and/or the controller/processor 380 of the UE 120 illustrated in FIG. 3 and/or the transmit processor 320 and/or the controller/processor 340 of the eNB 110 illustrated in FIG. 3. Means for receiving may comprise a receive processor (e.g., the receive processor 358) and/or an antenna(s) 352 of the UE120 illustrated in FIG. 3. Means for transmitting may comprise a transmit processor (e.g., the transmit processor 320) and/or an antenna(s) 334 of the eNB 120 illustrated in FIG. 3.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for obtaining system information by an apparatus comprising:
concurrently maintaining a first buffer for combining multiple transmissions of at least a first type of system information block (SIB) message across different system information (SI) message windows and a second buffer for combining multiple transmissions of at least a second type of SIB message within an SI window; and
decoding at least first and second types of SIB messages based on contents in the first and second buffers.

2. The method of claim 1, wherein the at least a first type of SIB message includes the second type of SIB message.

3. The method of claim 1, further comprising:
terminating combination of multiple transmissions of the at least a first type of SIB message across different SI message windows if one or more conditions are met.

4. The method of claim 3, wherein the one or more conditions comprise at least one of:
successful decoding of a particular type of SIB message;
expiration of a SIB modification period; or
failure to decode a SIB message within a given time period.

5. The method of claim 1 further comprising:
maintaining a list indicating one or more SIB message types considered mandatory; and
declaring a SIB decoding error after failing to decode a particular type of SIB message if the particular type of SIB message is indicated as mandatory based on the list.

6. The method of claim 5, wherein the one or more SIB message types considered mandatory depend, at least in part, on an operating mode of the apparatus.

7. The method of claim 1, wherein:
the first type of SIB message comprises a system information block type 1 (SIB1) message; and
the first buffer is used to combine multiple SIB1 messages across more than an 80 ms window.

8. The method of claim 1, wherein:
the first type of SIB message comprises a system information block type 1 (SIB1) message; and
further comprising, after successfully decoding a SIB1 message, employing the first buffer for combining SIB messages of a type other than SIB1.

9. The method of claim 1, wherein concurrently maintaining a first buffer for combining multiple transmissions of at least a first type of system information block (SIB) message across different system information (SI) message windows and a second buffer for combining multiple transmissions of at least a second type of SIB message within an SI window includes:
concurrently maintaining for combining transmissions of a particular type of SIB message in the first buffer and an un-combined transmission of the particular type of SIB message in the second buffer.

10. The method of claim 1, further comprising:
determining which type of SIB message to store for combining in the first buffer based on a priority scheme.

11. The method of claim 10, wherein the priority scheme dictates that a type of SIB message of a first priority is stored for combining in the first buffer if:
a type of SIB message of a second priority that is higher than the first priority message has been successfully decoded.

12. The method of claim 11, further comprising:
storing one or more SIB messages of a type having the first priority for combining in the first buffer; and
storing one or more SIB messages of a type having the second priority for combining in the first buffer regardless of whether the SIB message of the type having the first priority is decoded successfully when the SIB message of the type having the second priority needs to be decoded again.

13. An apparatus for wireless communications, comprising:
a processing system configured to:
concurrently maintain a first buffer for combining multiple transmissions of at least a first type of system information block (SIB) message across different system information (SI) message windows and a second buffer for combining multiple transmissions of at least a second type of SIB message within an SI window; and
decode at least first and second types of SIB messages based on contents in the first and second buffers.

14. The apparatus of claim 13, wherein the at least a first type of SIB message includes the second type of SIB message.

15. The apparatus of claim 13, wherein the processing system is further configured to terminate combination of multiple transmissions of the at least a first type of SIB message across different SI message windows if one or more conditions are met.

16. The apparatus of claim 15, wherein the one or more conditions comprise at least one of:
successful decoding of a particular type of SIB message;
expiration of a SIB modification period; or
failure to decode a SIB message within a given time period.

17. The apparatus of claim 13, wherein the processing system is further configured to:
maintain a list indicating one or more SIB message types considered mandatory; and
declare a SIB decoding error after failing to decode a particular type of SIB message if the particular type of SIB message is indicated as mandatory based on the list.

18. The apparatus of claim 17, wherein the one or more SIB message types considered mandatory depend, at least in part, on an operating mode of the apparatus.

19. The apparatus of claim 13, wherein:
the first type of SIB message comprises a system information block type 1 (SIB1) message; and
the first buffer is used to combine multiple SIB1 messages across more than an 80 ms window.

20. The apparatus of claim 13, wherein:
the first type of SIB message comprises a system information block type 1 (SIB1) message; and
wherein the processing system is further configured to, after successfully decoding a SIB1 message, employing the first buffer for combining SIB messages of a type other than SIB1.

21. The apparatus of claim 13, wherein concurrently maintaining a first buffer for combining multiple transmissions of at least a first type of system information block (SIB) message across different system information (SI) message windows and a second buffer for combining multiple transmissions of at least a second type of SIB message within an SI window includes:
concurrently maintaining for combining transmissions of a particular type of SIB message in the first buffer and an un-combined transmission of the particular type of SIB message in the second buffer.

22. The apparatus of claim 13, wherein the processing system is further configured to determine which type of SIB message to store for combining in the first buffer based on a priority scheme.

23. The apparatus of claim 22, wherein the priority scheme dictates that a type of SIB message of a first priority is stored for combining in the first buffer if:
a type of SIB message of a second priority that is higher than the first priority message has been successfully decoded.

24. The apparatus of claim 23, wherein the processing system is further configured to:
store one or more SIB messages of a type having the first priority for combining in the first buffer; and
store one or more SIB messages of a type having the second priority for combining in the first buffer regardless of whether the SIB message of the type having the first priority is decoded successfully when the SIB message of the type having the second priority needs to be decoded again.

25. An apparatus for wireless communications, comprising:
means for concurrently maintaining a first buffer for combining multiple transmissions of at least a first type of system information block (SIB) message across different system information (SI) message windows and a second buffer for combining multiple transmissions of at least a second type of SIB message within an SI window; and
means for decoding at least first and second types of SIB messages based on contents in the first and second buffers.

26. The apparatus of claim 25, wherein the at least a first type of SIB message includes the second type of SIB message.

27. The apparatus of claim 25, further comprising:
means for determining which type of SIB message to store for combining in the first buffer based on a priority scheme.

28. A computer-readable medium for wireless communications having instructions stored thereon for:
concurrently maintaining a first buffer for combining multiple transmissions of at least a first type of system information block (SIB) message across different system information (SI) message windows and a second buffer for combining multiple transmissions of at least a second type of SIB message within an SI window; and
decoding at least first and second types of SIB messages based on contents in the first and second buffers.

29. The computer-readable medium of claim 28, wherein the at least a first type of SIB message includes the second type of SIB message.

30. The computer-readable medium of claim 28, further comprising instructions stored thereon for:
determining which type of SIB message to store for combining in the first buffer based on a priority scheme.
